(19) United States
(12) Patent Application Publication
(10) Pub. No.: US 2004/0251701 A1
(43) Pub. Date: Dec. 16, 2004

(54) Lawn refuse collecting device and method

(76) Inventor: Lyle Raguse, Wheaton, MN (US)

Correspondence Address: HAHN LOESER & PARKS, LLP, One Go To Plaza, Suite 300, AKRON, OH, 44313-1076, US

(21) Appl. No.: 10/458,964

(22) Filed: Jun. 11, 2003

(51) Int. Cl. A01B 1/00

(52) U.S. Cl. 294/55

(57) ABSTRACT

A device and method for removing lawn refuse from the ground is described. The collection device comprises an elongated handle connected to a frame assembly. Secured to the frame assembly is a bag wherein the lawn refuse is collected as the device is pushed by an individual via the elongated handle.

### BACKGROUND AND SUMMARY OF THE INVENTION

The present invention is directed to an improved device and method for collecting and removing lawn refuse, such as fallen leaves, pine straw, grass, and the like from a lawn. In certain aspects, the invention is directed to a device suitable for collecting lawn refuse, wherein the device comprises a frame and a bag configured to collect the lawn refuse. The frame comprises a lower horizontal bar configured for contact upon the ground during operation of the device, an upper bar parallel to the lower bar, and two or more side bars connecting the upper and lower bars to form a contiguous frame. The bag comprises an open end through which the lawn refuse enters during operation, the open end having an outer periphery. The bag is secured to the frame about its outer periphery. The bag, in certain aspects, further comprises a horizontal floor portion secured to the lower bar of the frame and extending rearward therefrom, the floor portion further configured such that during operation of the device, the lower bar of the frame and the floor portion lie flush against the lawn, while the frame is further positioned in a plane forming an acute angle rearward relative to the floor portion. The device further comprises an elongated handle secured to the upper bar of the frame and extending rearward from the frame within the plane of the frame, thereby being positioned at the same acute angle relative to the floor portion of the bag.

The present invention is also directed, in certain aspects, to a device suitable for collecting lawn refuse, the device comprising a rectangular frame that further comprises an upper bar, a lower bar parallel to said upper bar, and two opposing side bars perpendicular to, and contiguous with, the upper and lower bars to form the rectangular frame; a bag comprising an open end having a rectangularly-shaped outer periphery secured to the frame, the bag further comprising a horizontal floor portion extending from the lower bar, a rear wall portion extending downward from the upper bar and integral with the floor portion, and two side portions, each of which are secured to one of the side bars and integral with the floor and rear wall portions of the bag. Spatially, the frame may be defined within a plane that is oriented at an acute angle rearward relative to the horizontal floor portion of the bag. The device in certain aspects further comprises an elongated handle secured to the upper bar of the frame and extends rearward from the frame along the same acute angle as the frame. The device further includes an elongated handle secured to the upper bar of the frame and extends rearward from the frame within the same plane of the frame, thereby being oriented at the same acute angle relative to the floor portion of the bag.

In certain aspects of the present invention, the horizontal floor portion and rear wall portions are substantially rectangular in shape while the two side portions are substantially triangular in shape, such that the bag, in combination with the frame, has a triangular configuration defined by the side walls, rear wall, floor, and frame.

In other aspects, the invention is directed to a method of collecting lawn refuse using collecting devices such as those described and illustrated herein. Here, the method comprises positioning the collection device along the ground, wherein the lower bar of the frame and the floor portion of the bag lie flush along the ground; grabbing the handle from behind the device; and pushing the device forward via the handle into the lawn refuse, such that the lower bar and the floor portion of the bag slide along the ground and underneath the lawn refuse, to thereby move the lawn refuse into the bag for collection. When the bag is full, the contents may be dumped out of the bag, and the collection process repeated.

### BRIEF DESCRIPTION OF THE FIGURES

FIG. 1 is a elevated perspective view of one embodiment of the present invention.

FIG. 2 is a side view of the inventive collecting device illustrated in FIG. 1.

FIG. 3 is a top front view of the inventive collecting device illustrated in FIG. 1.

FIG. 4 is a top front view of a second embodiment of the inventive collecting device.

FIG. 5 is a side view of third embodiment of the inventive collecting device.

FIG. 6 is an elevated perspective view of the bag portion of the collecting devices of the present invention.

FIG. 7 is an elevated perspective view of a fourth embodiment of the inventive collecting device.

FIG. 8 is an elevated perspective view of the embodiment shown in FIG. 1, further illustrating the operation of the invention by a person.

### DETAILED DESCRIPTION OF THE EMBODIMENTS OF THE INVENTION

The present invention is directed to an improved device and method for collecting and removing lawn refuse. As used herein “lawn refuse” includes, but is not limited to, fallen leaves, pine straw, grass, plant and tree cuttings, dead plants, and the like as well as other organic and inorganic waste matter found on the ground of a lawn, for example.

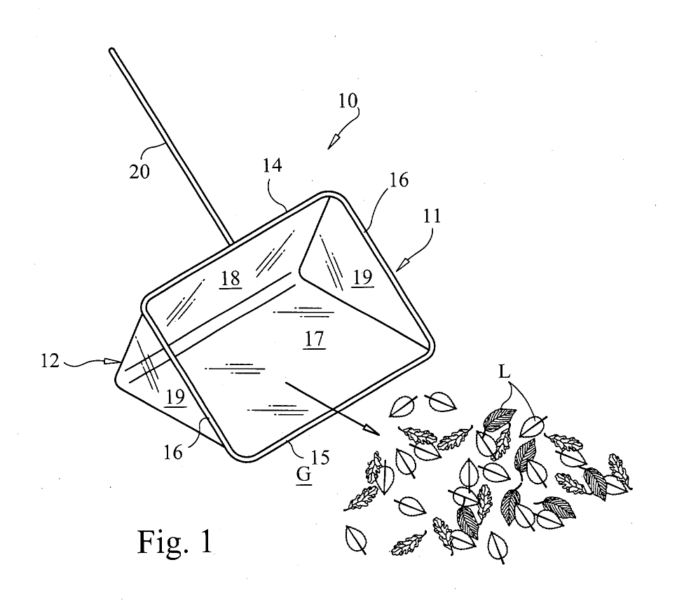

Referring now to the figures, the present invention is directed to a device 10 comprising a frame 11 and a bag 12. In one embodiment of the present invention, the frame is substantially rectangular in shape. As used herein, “substantially rectangular” is defined to describe a variety of parallelograms, wherein the opposite sides are parallel and equal to one another. The phrase includes rectangles (as shown in FIG. 1, for e.g., wherein one pair of sides has a different length than the adjacent pair of sides) as well as true squares (all four sides are of equal length) wherein adjacent sides form right angles to one another. The phrase “substantially rectangular” is also defined herein more broadly to include parallelograms wherein adjacent sides do not form right angles to one another. Moreover, the phrase “substantially rectangular” also includes four-sided planar configurations with rounded corners (as shown in the figures) as well as non-rounded corners (not shown).

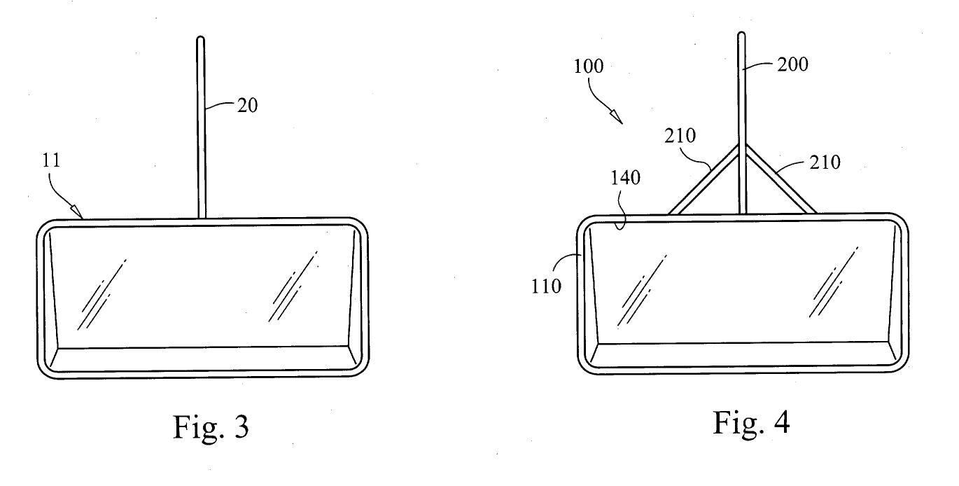

The bag 12 has an outer periphery 13 that is configured to be secured to the frame (see FIG. 6). FIGS. 1-3 illustrate one embodiment of the present invention, wherein the device comprises a frame 11 having an upper bar 14, a lower bar 15 parallel to the upper bar 14, and two opposing side bars 16 perpendicular to, and contiguous with, the upper and lower bars 14, 15. The bag 12 may be permanently secured to the frame by conventional fastening means know by those of skill in the art (e.g. adhesive, bolts, screws, and the like) or removably secured by conventional fastening means know by those of skill in the art (e.g. VELCRO, snaps, ties, zippers, string, wire, elastomeric bands, clamps, clips, magnets and the like). For ease of illustration, the fastening means are not illustrated in the figures.

The bars forming the frame 11 may be manufactured from PVC or aluminum tubing or solid rods as well as other types of durable plastic or metal tubing or rods. A smooth, light-weight material is preferred to aid in maneuverability and loading. The width or diameter size of the tubing or rod used may vary as desired; however, a preferred diameter (or width) size is 0.5 inch for a collection device designed to carry 5-pound maximum loads of lawn refuse.

The bag 12 as shown in the figures comprises a horizontal floor portion 17 extending from the lower bar 15 and is contiguous with a rear wall portion 18 that extends downward from the upper bar 14 of the frame. The bag 12 further comprises two side portions 19 extending from the respective side bars 16. As illustrated in FIGS. 1-2, and 6, for example, the side wall portions 19 have a substantially triangular configuration while the floor and rear wall portions of the bag have a substantially rectangular configuration. In certain embodiments, the bag may be formed of a durable material, such as polyethylene and other suitable plastics, canvas, and the like. A preferred material is one that has a smooth or slick surface (e.g. vinyl and other similarly smooth plastics) to provide minimal frictional contact between the outer side of the floor 17 and the ground G, thereby allowing the bag 12 to slide freely along the ground during the collection process. Preferably the material used is also durable, strong, and water and weather resistant. The bag may be used permanently, or it may be disposable, if desired.

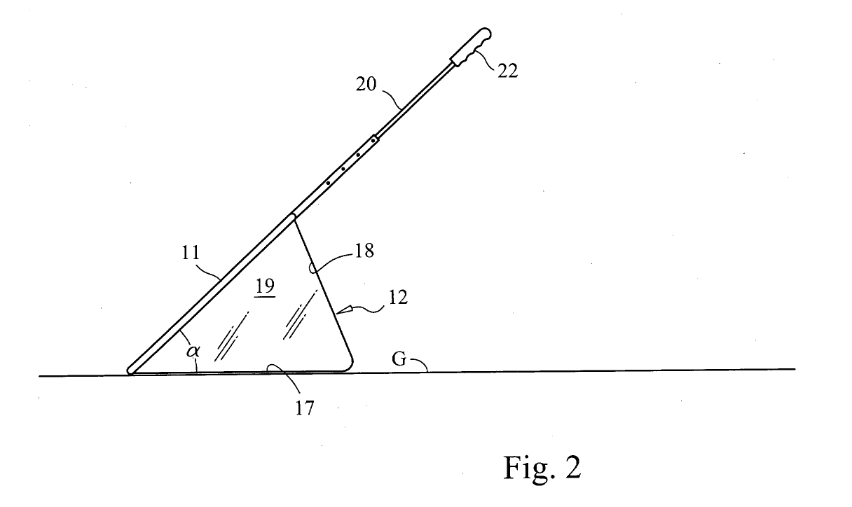

As illustrated most clearly in FIGS. 1-2, the frame 11 can be described as lying in a plane that is positioned at an acute angle α (i.e. less than 90 degrees) rearward relative to the ground G or horizontal floor portion 17 of the bag. A preferred angle α of orientation is about 45 degrees. To operate the device, a person P may stand behind the device 10, grasping the elongated handle 20 that is secured to or integral with the upper bar 14 of the frame 11 (see FIG. 8, for e.g.). As shown, the handle 20 may be oriented within the same acute angle α relative to the ground G or floor portion 17 of the bag as is the plane of the frame 11. The person may then push the device forward in the direction of the arrow (FIGS. 1 and 8), thereby sliding the floor portion 17 of the bag and lower bar 15 of the frame along the ground. When the lower bar 17 comes in contact with the lawn refuse, such as leaves L, for example, the lower bar 14 and floor portion 17 slide underneath the refuse. By selecting materials for the frame, such as smooth, lightweight metals or plastic materials, as well as smooth plastics or canvas materials for the bag, the device may be easily maneuvered along the ground G.

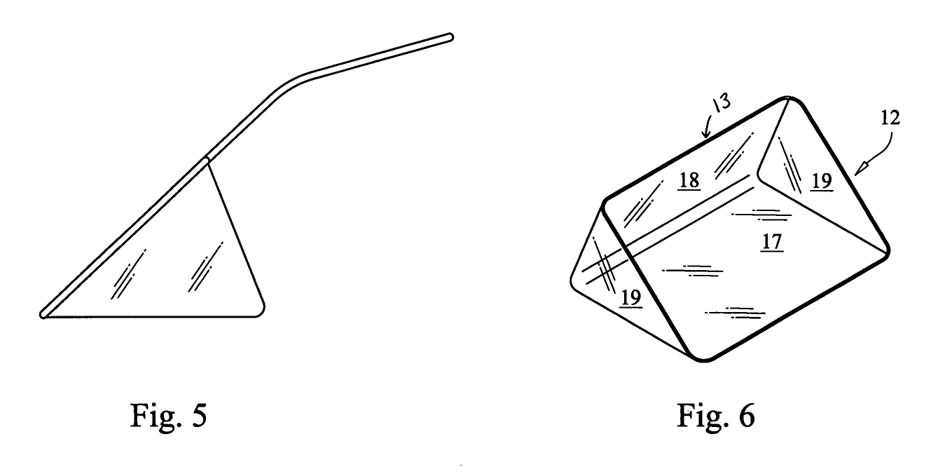

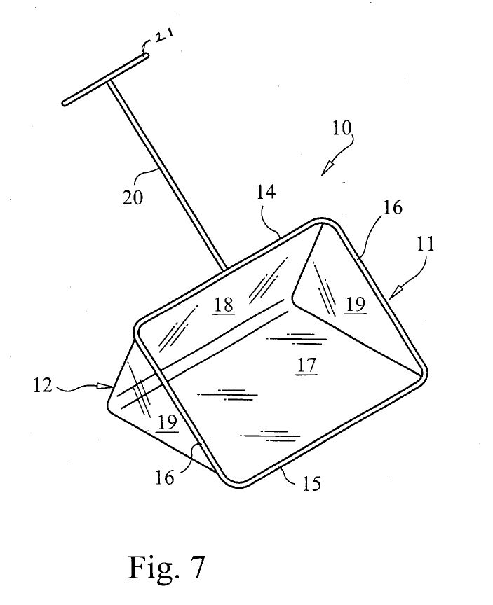

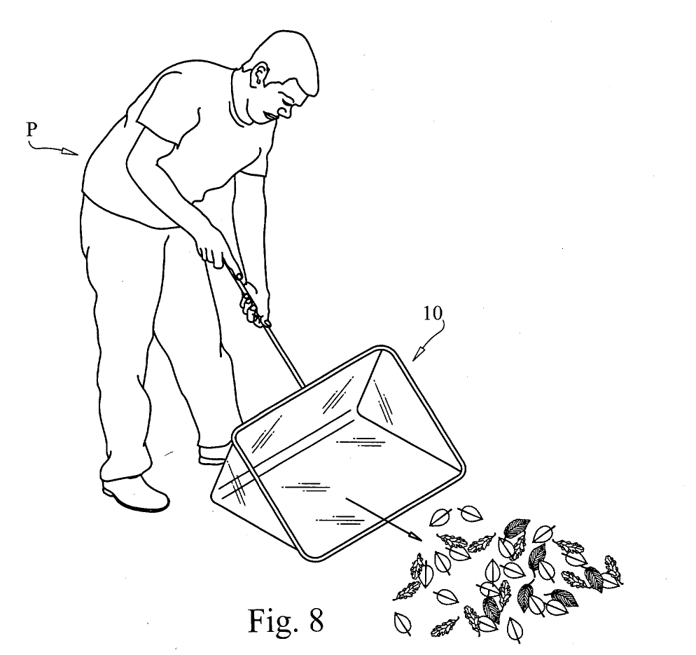

As shown in the figures, the handle 20 may be straight (FIGS. 1-4) or it may be bent slightly downward (FIG. 5), if desired to aid in handling. The straight handle design shown in FIGS. 1-4, for example, is preferred, however. The handle 20 may be a single solid piece or it may comprise two or more segments contiguous with one another or secured to one another in a telescopic fashion (i.e. an adjustable tube within a tube to provide length adjustment) (not shown). FIG. 7 illustrates another embodiment of the collecting device wherein the handle includes a T-shaped hand grip 21; however, a molded hand grip 22, as shown in FIG. 2, is preferred.

FIG. 4 illustrates a another embodiment of the present invention, wherein secured to the upper bar 140 of the frame 110 and handle 200 are a pair of support arms 210. These support arms 210 provide added stability or support to the handle, especially for embodiments wherein the frame and bag may be heavier or larger and/or when particularly large quantities of refuse are to be collected prior to emptying of the bag.

1. A device suitable for removing lawn refuse, said device consisting essentially of:
a. a rectangular frame comprising an upper bar, a lower bar parallel to said upper bar, and two opposing side bars perpendicular to, and contiguous with, said upper and lower bars to form said rectangular frame;
b. a bag comprising an open end having a rectangularly-shaped outer periphery permanently secured to said frame;
c. said bag further comprising a horizontal floor portion extending from said lower bar, a rear wall portion extending downward from said upper bar and integral with said floor portion, and two side portions, each of said side portions secured to one of said side bars and integral with said floor and rear wall portions of said bag, and whereby spatially said frame is within a plane oriented at an acute angle rearward relative to said horizontal floor portion of said bag; and
d. an elongated handle secured to said upper bar of said frame and extending rearward from said frame within said plane, thereby oriented at the same acute angle relative to said floor portion of said bag.

2. The device of claim 1, wherein said handle is adjustable.

3. The device of claim 1, wherein said acute angle is approximately 45 degrees.

4. The device of claim 1, wherein said bag is formed of a material having a sufficiently smooth surface, thereby allowing said bag to move freely along an area of ground and beneath said lawn refuse.

5. A device suitable for removing lawn refuse, said device consisting essentially of:
a. a rectangular frame comprising an upper bar, a lower bar parallel to said upper bar, and two opposing side bars perpendicular to, and contiguous with, said upper and lower bars to form said rectangular frame;
b. a bag comprising an open end having a rectangularly-shaped outer periphery permanently secured to said frame;
c. said bag further comprising a horizontal rectangular floor portion extending from said lower bar, a rectangular rear wall portion extending downward from said upper bar and integral with said floor portion, and two triangular side portions, each of said side portions secured to one of said side bars and integral with said floor and rear wall portions of said bag, such that said bag, in combination with said frame, has a triangular configuration defined by said side portions, rear wall portion, floor portion, and said frame, and whereby spatially said frame is within a plane oriented at an acute angle rearward relative to said horizontal floor portion of said bag; and
d. an elongated handle secured to said upper bar of said frame and extending rearward from said frame within said plane, thereby oriented at the same acute angle relative to said floor portion of said bag.

6. The device of claim 5, wherein said handle is adjustable.

7. The device of claim 5, wherein said acute angle is approximately 45 degrees.

8. The device of claim 5, wherein said bag is formed of a material having a sufficiently smooth surface, thereby allowing said bag to move freely along an area of ground and beneath said lawn refuse.

9. The device of claim 8, wherein said material forming said bag comprises a smooth plastic.

10. A device suitable for removing lawn refuse from a lawn, said device consisting essentially of:
a. a frame, said frame having a lower horizontal bar configured for contact upon the lawn during use of said device, an upper bar parallel to said lower bar, and two or more side bars connecting said upper and lower bars to form a contiguous frame;
b. a bag comprising an open end with an outer periphery, said bag permanently secured to said frame about said outer periphery;
c. said bag having a horizontal floor portion secured to said lower bar of said frame and extending rearward therefrom, said floor portion further configured such that during use of said device, said floor portion is positioned flat against the lawn and whereby said frame is further positioned at an acute angle rearward relative to said floor portion; and
d. an elongated handle secured to said upper bar of said frame and extending rearward from said frame along the same acute angle as said frame.

11. The device of claim 10, wherein said handle is adjustable.

12. The device of claim 10, wherein said acute angle is approximately 45 degrees.

13. The device of claim 10, wherein said bag is formed of a material having a sufficiently smooth surface, thereby allowing said bag to move freely along said lawn and beneath said lawn refuse.

14. The device of claim 13, wherein said material forming said bag comprises a smooth plastic.

15. A method of removing lawn refuse from the ground, said method comprising:
positioning the device of claim 1 along the ground, wherein said lower bar of said frame and said floor portion of said bag are flush along the ground;
grabbing said handle from behind said device; and
pushing said device forward via said handle into said lawn refuse, such that said lower bar and said floor portion of said bag slide along the ground and underneath said lawn refuse, thereby moving said lawn refuse into said bag for collection.

16. The method of claim 15, wherein said lawn refuse comprises leaves.

17. The method of claim 15, wherein said lawn refuse comprises pine straw.

18. The method of claim 15, wherein said handle is positioned an acute angle of approximately 45 degrees.

19. The method of claim 15, wherein said bag is formed of a material having a sufficiently smooth surface, thereby allowing said bag to move freely along said ground and beneath said lawn refuse.

20. The method of claim 19, wherein said material forming said bag comprises a smooth plastic.

21-26. (cancelled).

27. A method of removing lawn refuse from the ground, said method comprising:
positioning the device of claim 10 along the ground, wherein said lower bar of said frame and said floor portion of said bag are flush along the ground;
grabbing said handle from behind said device; and
pushing said device forward via said handle into said lawn refuse, such that said lower bar and said floor portion of said bag slide along the ground and underneath said lawn refuse, thereby moving said lawn refuse into said bag for collection.

28. The method of claim 27, wherein said lawn refuse comprises leaves.

29. The method of claim 27, wherein said lawn refuse comprises pine straw.

30. The method of claim 27, wherein said handle is positioned an acute angle of approximately 45 degrees.

31. The method of claim 27, wherein said bag is formed of a material having a sufficiently smooth surface, thereby allowing said bag to move freely along said ground and beneath said lawn refuse.

32. The method of claim 27, wherein said material forming said bag comprises a smooth plastic.
